(19) United States
(12) Patent Application Publication
(10) Pub. No.: US 2025/0166142 A1
(43) Pub. Date: May 22, 2025

(54) IMAGE PROCESSING DEVICES, ELECTRONIC DEVICE AND IMAGE PROCESSING METHODS

(71) Applicant: Sony Semiconductor Solutions Corporation, Atsugi-shi, Kanagawa (JP)

(72) Inventors: Michael DANNER, Stuttgart (DE); Lev MARKHASIN, Stuttgart (DE); Hans WOLFF, Stuttgart (DE)

(73) Assignee: Sony Semiconductor Solutions Corporation, Atsugi-shi, Kanagawa (JP)

(21) Appl. No.: 18/842,100

(22) PCT Filed: Mar. 2, 2023
(86) PCT No.: PCT/EP2023/055361

§ 371 Date: Aug. 28, 2024

(30) Foreign Application Priority Data
Mar. 4, 2022 (EP) 22160195.8

(51) Int. Cl. G06T 5/77; G06T 5/60; G06T 11/60

(52) U.S. Cl. CPC G06T 5/77; G06T 5/60; G06T 11/60; G06T 2207/10016

(57) ABSTRACT

An image processing device is disclosed, featuring interface circuitry to receive image data representing a first image with an aspect ratio smaller than one. This image could be a photograph or a still frame from a video. The device's processing circuitry generates a second image with an aspect ratio greater than one by adding image areas to the lateral sides of the first image. The processing circuitry extends the background into these added areas and identifies foreground objects. If a foreground object is incomplete, the device determines and adds a visual representation of the missing part to complete the object in the extended image areas.

### FIELD

The present disclosure relates to image processing. In particular, examples of the present disclosure relate to image processing devices, an electronic device and image processing methods.

### BACKGROUND

Traditionally, video material has been in landscape format for cinema, television or computer screens. Screening of video material in landscape format is advantageous over screening of video material in portrait format as human eyes are primarily designed to see more of the world horizontally than vertically. Therefore, a user feels a more natural sense of sight when watching video material in landscape format.

However, due to the increasing usage of smartphones and other devices with screens in portrait format, more and more videos are shot in portrait mode. There are a plurality of approaches for converting a portrait format video into a landscape format video such as filling the black side border with a blurred background or cropping a portrait format video into a landscape format video. None of these approaches is able to convert a portrait format video into a landscape format video of compelling quality.

Hence, there may be a demand for improved aspect ratio conversion of images.

### SUMMARY

This demand is met by devices and methods in accordance with the independent claims. Advantageous embodiments are addressed by the dependent claims.

According to a first aspect, the present disclosure provides an image processing device. The image processing device comprises interface circuitry configured to receive first image data representing a first image exhibiting a first aspect ratio smaller than one. The first image is a photograph or a still frame of a recorded video. Further, the image processing device comprises processing circuitry configured to generate second image data representing a second image exhibiting a second aspect ratio greater than one. For generating the second image data, the processing circuitry is configured to add a first image area and a second image area to the first image at opposite lateral sides of the first image. Additionally, for generating the second image data, the processing circuitry is configured to extend a background in the first image into the first and the second image area. For generating the second image data, the processing circuitry is further configured to identify at least one foreground object in the first image and to determine whether the foreground object is complete in the first image. If it is determined that the foreground object is not complete in the first image, the processing circuitry is configured to determine a visual representation of a missing part of the foreground object and arrange the visual representation of the missing part into one of the first image area and the second image area to complete the foreground object.

According to a second aspect, the present disclosure provides an image processing device. The image processing device comprises interface circuitry configured to receive first image data representing a first image exhibiting a first aspect ratio smaller than one. The first image is a photograph or a still frame of a recorded video depicting a scene. The first image data comprise metadata indicative of a respective class, a respective size and a respective position of one or more object in a surrounding of the scene not depicted in the first image. The image processing device further comprises processing circuitry configured to generate second image data representing a second image exhibiting a second aspect ratio greater than one. For generating the second image data, the processing circuitry is configured to add a first image area and a second image area to the first image at opposite lateral sides of the first image. Additionally, for generating the second image data, the processing circuitry is configured to extend a background in the first image into the first and the second image area, and to identify at least one foreground object in the first image. Further, for generating the second image data, the processing circuitry is configured to determine whether the foreground object is complete in the first image. If it is determined that the foreground object is not complete in the first image, the processing circuitry is configured to determine a visual representation of a missing part of the foreground object and to arrange the visual representation of the missing part into one of the first image area and the second image area to complete the foreground object. Additionally, the processing circuitry is configured to determine a respective visual representation of the one or more object in the surrounding based on the respective class and the respective size of the one or more object indicated by the metadata. The processing circuitry is in addition configured to add the respective visual representation of the one or more object in the surrounding into a respective one of the first image area and the second image area based on the respective position of the one or more object indicated by the metadata.

According to a third aspect, the present disclosure provides an image processing device. The image processing device comprises interface circuitry configured to receive first image data representing a first image exhibiting a first aspect ratio smaller than one. The first image is a photograph or a still frame of a recorded video. In addition, the image processing device comprises processing circuitry configured to identify a background in the first image, and to identify one or more foreground object in the first image. The image processing device is further configured to determine a respective size and a respective position of the one or more foreground object. Additionally, the image processing device is configured to generate second image data indicative of a respective class, the respective size and the respective position of the one or more foreground object and of a class of the background. The image processing device is configured to store the second image data in a memory.

According to a fourth aspect, the present disclosure provides an electronic device. The electronic device comprises an image sensor configured to generate the first image data based on light received from a scene. Additionally, the electronic device comprises an image processing device according to an aspect of the present disclosure.

According to a fifth aspect, the present disclosure provides an image processing method. The method comprises receiving first image data representing a first image exhibiting a first aspect ratio smaller than one. The first image is a photograph or a still frame of a recorded video. In addition, the method comprises generating second image data representing a second image exhibiting a second aspect ratio greater than one. Generating the second image data comprises adding a first image area and a second image area to the first image at opposite lateral sides of the first image. Additionally, generating the second image data comprises extending a background in the first image into the first and the second image area. Generating the second image data further comprises identifying at least one foreground object in the first image and determining whether the foreground object is complete in the first image.

If it is determined that the foreground object is not complete in the first image, generating the second image data additionally comprises determining a visual representation of a missing part of the foreground object, and arranging the visual representation of the missing part into one of the first image area and the second image area to complete the foreground object.

### BRIEF DESCRIPTION OF THE FIGURES

Some examples of apparatuses and/or methods will be described in the following by way of example only, and with reference to the accompanying figures, in which

FIG. 1 illustrates a first example of an image processing device;

FIG. 2 illustrates an exemplary first image;

FIG. 3 illustrates an exemplary second image;

FIG. 4 illustrates an exemplary surrounding of a scene;

FIG. 5 illustrates an exemplary second image;

FIG. 6 illustrates a flowchart of a first example of an image processing method;

FIG. 7 illustrates a second example of an image processing device;

FIG. 8 illustrates a flowchart of a second example of an image processing method;

FIG. 9 illustrates a third example of an image processing device;

FIG. 10 illustrates an exemplary second image;

FIG. 11 illustrates a flowchart of a third example of an image processing method; and

FIG. 12 illustrates an example of an electronic device.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

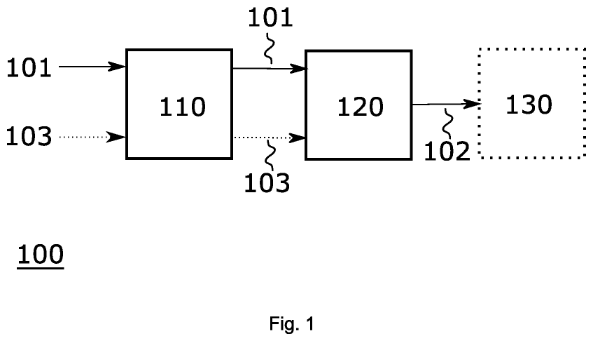

FIG. 1 illustrates an image processing device 100. The image processing device 100 comprises interface circuitry 110 configured to receive first image data 101. For example, the interface circuitry 110 may be configured to receive the first image data 101 from an (electronic) image sensor of a camera or from a memory.

The first image data 101 represent a first image. The first image is a photograph (i.e. an image created by light falling on a photosensitive surface such as a photographic film or an image sensor) or a still frame of a recorded video (i.e. a single static image taken from a series of recorded still images forming the recorded video). The first image exhibits a first aspect ratio. The aspect ratio of an image is generally defined as the ratio of its width to its height. The first aspect ratio smaller than one. In other words, the first image is in portrait format.

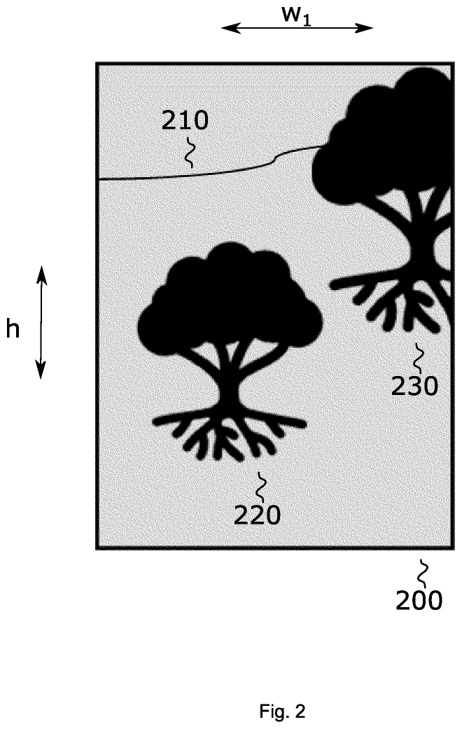

An exemplary first image 200 is illustrated in FIG. 2. The first image 200 exhibits a height h and a width w₁. The width w₁ is smaller than the height h pf the first image 200 such that the aspect ratio of the first image 200 is smaller than one. One or more element such as a background 210 and the trees 220 and 230 are depicted in the first image 200.

Returning back to FIG. 1, the image processing device 100 further comprises processing circuitry 120. The processing circuitry 120 is coupled to the interface circuitry 110. The processing circuitry 120 is configured to receive and process the first image data 101. For example, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be coupled to, e.g., read only memory (ROM) for storing software, random access memory (RAM) and/or non-volatile memory. Optionally, the image processing device 100 may comprise further circuitry.

In particular, the processing circuitry 120 is configured to generate second image data 102 based on the first image data. The second image data 102 represent a second image. The second image exhibits a second aspect ratio greater than one. For example, the second image may be in landscape format, in panoramic format (wide format; e.g. exhibiting an aspect ratio of two or greater) or in 360° panoramic format (i.e. exhibiting an angle of view of 360° in the width dimension).

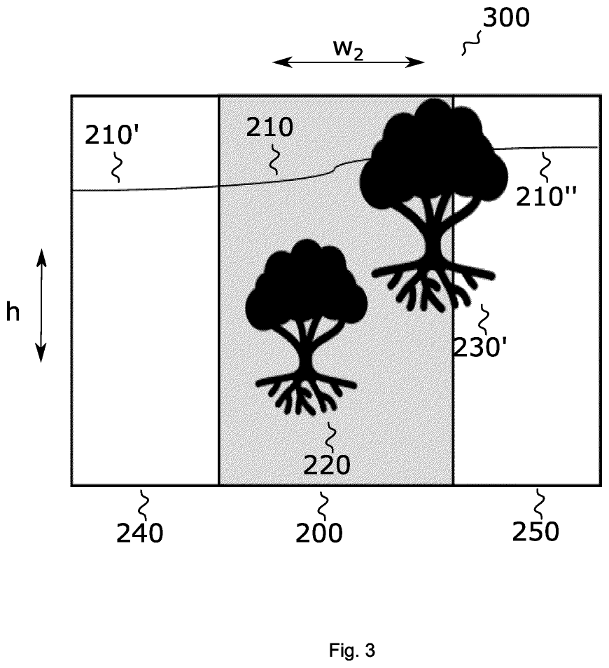

An exemplary second image 300 is illustrated in FIG. 3. The second image 300 comprises (the image area of) the first image 200. For generating the second image data 102, the processing circuitry 120 is configured to add a first image area 240 and a second image area 250 to (the image area of) the first image 220 at opposite lateral sides of (the image area of) the first image 200. The image area of the second image 300 is given by the (image area of the) first image 200, the first image area 240 and the second image area 250. The first image area 240 and the second image area 250 may be of rectangular shape like the first image 200.

The first image area 240 and the second image area 250 exhibit the same height h as (the image area of) the first image 200. The respective width of the first image area 240 and the second image area 250 may be identical to each other. However, it is to be noted that the widths of the first image area 240 and the second image area 250 need not be identical to each other. The respective width of the first image area 240 and the second image area 250 may be smaller or greater than the width w₁ of (the image area of) the first image 200. The width w₂ of the second image 300 is the sum of the width w₁ of (the image area of) the first image 200 and the widths of the first image area 240 and the second image area 250. For example, the widths of the first image area 240 and the second image area 250 may be selected (adjusted) based on a target aspect ratio of the second image 300. The width w₂ of (the image area of) the second image 300 is greater than the height h of (the image area of) the second image 300.

Additionally, for generating the second image data, the processing circuitry 120 is configured to extend the background 210 in the first image 200 into the first image area 240 and the second image area 250. As a result, a first background extension 210′ is present in the first image area 240 and a second background extension 210″ is present in the second image area 250. Various techniques may be used by the processing circuitry 120 for extending the background 210 into the first image area 240 and the second image area 250. The processing circuitry 120 may be configured to extend the background 210 into the first image area 240 and the second image area 250 using a trained machine-learning model.

The trained machine-learning model is a data structure and/or set of rules representing a statistical model that the processing circuitry 120 uses to perform a certain task such as the extension of the background 210 into the first image area 240 and the second image area 250 without using explicit instructions, instead relying on models and inference. The data structure and/or set of rules represents learned knowledge (e.g. based on training performed by a machine-learning algorithm). For example, in machine-learning, instead of a rule-based transformation of data, a transformation of data may be used, that is inferred from an analysis of training data.

The machine-learning model is trained by a machine-learning algorithm. The term “machine-learning algorithm” denotes a set of instructions that are used to create, train or use a machine-learning model. For the machine-learning model to extend the background 210 of the first image 200 into the first image area 240 and the second image area 250, the machine-learning model may be trained using training image data as input and training images with exemplarily extended backgrounds as output. By training the machine-learning model with a large set of training data and associated training content information, the machine-learning model “learns” to extend backgrounds depicted in the training data (e.g. training images), so that backgrounds which are not included in the training data can be extended using the machine-learning model. By training the machine-learning model using training image data and a desired output, the machine-learning model “learns” a transformation between the image data and the output, which can be used to provide an output based on non-training image data provided to the machine-learning model.

The machine-learning model may be trained using training input data (e.g. training image data). For example, the machine-learning model may be trained using a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. For example, a training sample may comprise training image data as input data and one or more images with exemplarily extended backgrounds as desired output data.

Apart from supervised learning, semi-supervised learning may be used. In semi-supervised learning, some of the training samples lack a corresponding desired output value. Supervised learning may be based on a supervised learning algorithm (e.g. a classification algorithm or a similarity learning algorithm). Classification algorithms may be used as the desired outputs of the trained machine-learning model are restricted to a limited set of values (categorical variables), i.e., the input is classified to one of the limited set of values (type of background). Similarity learning algorithms are similar to classification algorithms but are based on learning from examples using a similarity function that measures how similar or related two objects are.

Apart from supervised or semi-supervised learning, unsupervised learning may be used to train the machine-learning model. In unsupervised learning, (only) input data are supplied and an unsupervised learning algorithm is used to find structure in the input data such as training image data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters. The input data for the unsupervised learning may be training image data.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, additional techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

For example, the machine-learning model may be an Artificial Neural Network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values (e.g. the image data), hidden nodes that are (only) connected to other nodes, and output nodes that provide output values (e.g. image with extended background). Each node may represent an artificial neuron. Each edge may transmit information from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an ANN may comprise adjusting the weights of the nodes and/or edges of the ANN, i.e., to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values (e.g. image data) that belong to one of two categories (e.g. different background types). The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

In still other examples, the machine-learning model may be a Generative Adversarial Network (GAN). For training a GAN, two neural networks contest with each other in a game (in the form of a zero-sum game, where one agent's gain is another agent's loss). A GAN is based on the “indirect” training through the discriminator, another neural network that is able to tell how much an input is “realistic”, which itself is also being updated dynamically. This basically means that the generator is not trained to minimize the distance to a specific image, but rather to fool the discriminator. This enables the model to learn in an unsupervised manner. Given a training set, this technique learns to generate new data with the same statistics as the training set. For example, a GAN trained on photographs or images can generate new photographs or images that look at least superficially authentic to human observers, having many realistic characteristics. Accordingly, a trained GAN may be used for extending the background 210 into the first image area 240 and the second image area 250.

In some examples, the machine-learning model may be a combination of the above examples.

Exemplary machine-learning models that may be used for extending the background 210 into the first image area 240 and the second image area 250 are described in D. Krishnan et al., “Boundless: Generative Adversarial Networks for Image Extension,” 2019 IEEE/CVF International Conference on Computer Vision (ICCV), 2019, pp. 10520-10529, DOI: 10.1109/ICCV.2019.01062, https://doi.org/10.1109/ICCV.2019.01062 and Y. Wang et al., “Sketch-Guided Scenery Image Outpainting” IEEE Trans. Image Process. 30: 2643-2655 (2021), DOI: 10.1109/TIP.2021.3054477, https://arxiv.org/abs/2006.09788, the content of which is incorporated herein by reference. However, it is to be noted that the present disclosure is not limited to these specific examples of machine-learning models. Other machine-learning models may be used as well.

According to examples, the processing circuitry 120 may be configured to identify the background 210 in the first image 200 prior to extending the background 210 into the first image area 240 and the second image area 250. For example, a machine-learning model may be used for identifying the background 210 in the first image 200. The same or different machine-learning models may be used for identifying the background 210 in the first image 200 and extending the background 210 into the first image area 240 and the second image area 250. The identification of the background 210 in the first image 200 may be based on various techniques such as Single Shot Detector (SSD), You Only Look Once (YOLO) or Deeply Supervised Object Detector (DSOD). However, it is to be noted that the present disclosure is not limited to the above examples. Other techniques for object detection (object identification) may be used as well.

For generating the second image data, the processing circuitry 120 is further configured to identify at least one foreground object such as one of the trees 220 and 230 in the first image 200. Various techniques such as SSD, YOLO or DSOD may be used for detecting and identifying the one or more foreground object in the first image 200. However, it is to be noted that the present disclosure is not limited to the above examples. Other techniques for object detection (object identification) may be used as well.

Further, the processing circuitry 120 is configured to determine whether the foreground object is complete in the first image. For example, in the example of FIG. 2, the processing circuitry 120 determines that the trees 220 and 230 are foreground objects. The processing circuitry 120 further determines for both trees 220 and 230 whether the respective tree is complete in the first image 200. As can be seen from FIG. 2, the tree 220 is depicted completely in the first image 200, while part of the tree 230 is not depicted in the first image 200.

If it is determined that a foreground object such as the tree 230 is not complete in the first image 200, the processing circuitry 120 is configured to determine a visual representation of a missing part of the foreground object and arrange the visual representation of the missing part into one of the first image area 240 and the second image area 250 to complete the foreground object. In the example of FIG. 2, the tree 230 is not complete such that the processing circuitry 120 determines a visual representation of a missing part of the tree 230 and arranges the visual representation of the missing part of the tree 230 in the second image area 250 to complete the tree 230. The accordingly completed tree 230′, which extends in the image area of the original first image 200 and the second image are 250, is depicted in FIG. 3.

For example, the processing circuitry 120 may be configured to determine and arrange the visual representation of the missing part of the foreground object into the one of the first image area 240 and the second image area 250 using a trained machine-learning model. For example, a GAN trained with training image data may be used. Exemplary machine-learning models that may be used for determining and arranging the visual representation of the missing part of the foreground object into the one of the first image area 240 and the second image area 250 are described in H. Wu et al., “GP-GAN: Towards Realistic High-Resolution Image Blending” in Proceedings of the 27th ACM International Conference on Multimedia (MM '19). Association for Computing Machinery, New York, NY, USA, 2487-2495, DOI: https://doi.org/10.1145/3343031.3350944 and K. Nazeri et al., “EdgeConnect: Generative Image Inpainting with Adversarial Edge Learning” CoRR abs/1901.00212 (2019), http://arxiv.org/abs/1901.00212, the content of which is incorporated herein by reference. However, it is to be noted that the present disclosure is not limited to these specific examples of machine-learning models. Other machine-learning models may be used as well.

The image processing device 100 may allow to autocomplete non-existent lateral margins of the first image for converting the first image to the second image. For example, the image processing device 100 may allow to convert an image from portrait format to landscape format. In particular, the image processing device 100 may allow to complete the scene in the first image by extending the background and by autocompleting the foreground based on the foreground objects visible in the first image. The image processing device 100 may, hence, enable aspect ratio conversion of images with compelling quality.

The processing circuitry 120 may be further configured to store the second image data 102 in a memory 130. For example, the memory 130 may be a Non-Volatile Memory (NVM) including high-speed electrically erasable memory (commonly referred to as Flash memory), Phase change Random Access Memory (PRAM) or Magnetoresistive Random Access Memory (MRAM). The memory may be implemented as one or more of solder down packaged integrated circuits, socketed memory modules and plug-in memory cards. The memory 130 may allow further circuitry to access the completed second image as represented by the second image data 102.

The image processing device 100 may optionally further support extended completion of the lateral margins of the first image. As illustrated in FIG. 1, the interface circuitry 110 may optimally further be configured to receive third image data 103 representing a surrounding of the scene not depicted in the first image. In other words, while the first image data 101 represent the scene depicted in the first image, the third image data 103 represent the surrounding of the scene that is not depicted in the first image. For example, the first image data 101 may be obtained by taking a photography or recording a video with a camera. After taking the photo or recording the video, the camera may be slightly moved left and/or right and/or up and/or down to capture the surrounding of the scene previously recorded in the photography or the video. Accordingly, the third image data 103 represent one or more object that are not depicted or at least not completely depicted in the first image.

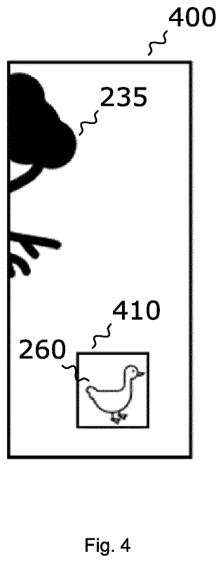

FIG. 4 illustrates an exemplary surrounding 400 of the scene depicted in the first image 200 illustrated in FIG. 2. The missing part 235 of the tree 230 is included in the surrounding 400 as well as a duck 260. The missing part 235 of the tree 230 and the duck 260 are not depicted in the first image 200.

For generating the second image data 102, the processing circuitry 120 is in some examples further configured to identify one or more object such as the duck 260 in the surrounding 400 represented by the third image data 103. Various techniques such as SSD, YOLO or DSOD may be used for detecting and identifying the one or more object in the surrounding 400. However, it is to be noted that the present disclosure is not limited to the above examples. Other techniques for object detection (object identification) may be used as well.

Further, the processing circuitry 120 is configured to determine a respective size and a respective position of the one or more object in the surrounding 400 relative to the scene depicted in the first image. For example, when identifying the one or more object in the surrounding 400, the processing circuitry 120 may be configured to determine a respective bounding box for the one or more object in the surrounding. In the example of FIG. 4, an exemplary bounding box 410 is illustrated for the duck 260. Accordingly, the respective size and the respective position of the one or more object in the surrounding may be a respective size and a respective position of the respective bounding box for the one or more object in the surrounding. That is, the size and the position of the bounding box 410 may be used as the size and the position of the duck 260. However, it is to be noted that the present disclosure is not limited to the above examples. Other techniques for position and seize determination may be used as well.

The processing circuitry 120 is configured to add metadata to the second image data 102 indicative of a respective class, the respective size and the respective position of the one or more object in the surrounding. For example, the metadata may be textual data. In the example of FIG. 4, the processing circuitry 120 adds metadata indicating the class, the size and the position of the duck 260 to the second image data 102.

The processing circuitry 120 may store the second image data 102 (including the metadata) in the memory 130. Further, the processing circuitry 120 may discard the third image data 103 after generating the second image data 102.

While the background is extended and the visible foreground is completed in the second image, the additional metadata may allow to further complete the image by adding one or more object not visible in the initial first image 200. Circuitry processing the second image data 102 including the metadata may retrieve the information about the one or more object not visible in the initial first image 200 from the metadata and add one or more corresponding virtual representation to the second image. The metadata may allow to efficiently store the information on the one or more object not visible in the initial first image 200.

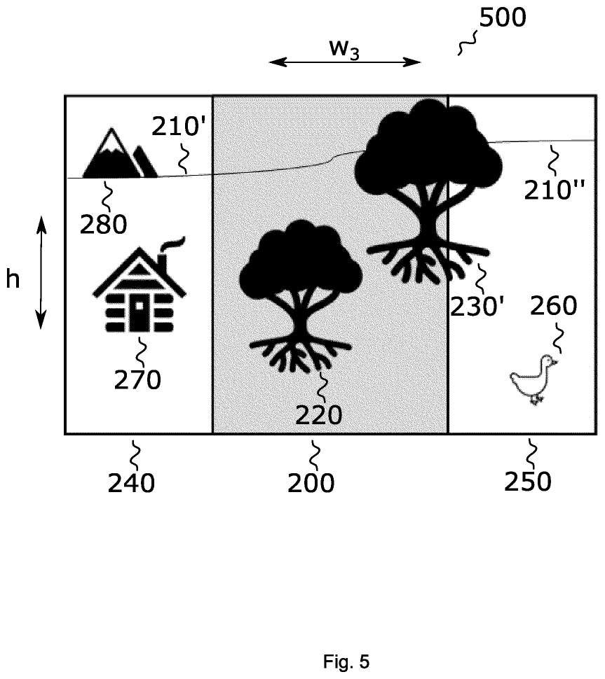

Alternatively to determining and storing the metadata, the processing circuitry 120 may be configured to complete the image by adding one or more object not visible in the initial first image 200 to the second image. This is exemplarily illustrated in FIG. 5. In the example of FIG. 5, the third image data 103 is processed substantially as described above—except for the determination and storage of the metadata.

The tree 230 partially depicted in the foreground of the first image 200 is autocompleted to the tree 230′ as described above. In addition, a visual representation of the duck 260 is added to the second image area 250. In particular, the visual representation of the duck 260 is generated based on the previously determined class and the previously determined size of the duck 260 in the surrounding 400. The visual representation of the duck 260 is added into the second image area 250 based on the previously determined position of the duck 260 in the surrounding 400.

In the example of FIG. 5, the third image data 103 further indicate that a house 270 and a mountain 280 are present in the surrounding of the first image 200. Accordingly, the house 270 and the mountain 280 are identified by the processing circuitry in the third image data 103, and a respective class, a respective size and a respective position of the house 270 and the mountain 280 relative to the scene depicted in the first image 200 are determined. Various techniques such as SSD, YOLO or DSOD may be used for detecting and identifying the house 270 and the mountain 280. For example, bounding boxes may be used to determine the respective size and the respective position of the house 270 and the mountain 280. A respective visual representation of the house 270 and the mountain 280 is determined based on the respective determined class and the respective determined size of the house 270 and the mountain 280. The visual representations of the house 270 and the mountain 280 are added into the first image area 240 based on the previously determined positions of the house 270 and the mountain 280.

It is to be noted that the duck 260, the house 270 and the mountain 280 are merely examples for possible objects in the surrounding of the scene depicted in the first image 200. More, less or other objects may be in in the surrounding of the scene depicted in the first image. Therefore, in more general terms, the processing circuitry 120 is configured to identify one or more object in a surrounding of the scene based on the third image data 103, wherein the surrounding is not depicted in the first image. The processing circuitry 120 is further configured to determine a respective class, a respective size and a respective position of the one or more object in the surrounding relative to the scene depicted in the first image. For example, the information about the respective class, the respective size and the respective position of the one or more object in the surrounding may be determined as textual information. Additionally, the processing circuitry 120 is configured to determine a respective visual representation of the one or more object in the surrounding based on the respective determined class and the respective determined size of the one or more object in the surrounding. The processing circuitry 120 is configured to add the respective visual representation of the one or more object in the surrounding into a respective one of the first image area and the second image area based on the respective determined position of the one or more object in the surrounding.

The processing circuitry 120 may be configured to determine and add the respective visual representation of the one or more object in the surrounding into the respective one of the first image area and the second image area using a trained machine-learning model. For example, a deep GAN for object-driven text-to-image synthesis may be used to determine and add the respective visual representation of the one or more object in the surrounding into the respective one of the first image area and the second image area. Exemplary machine-learning models that may be used for determining and adding the respective visual representation of the one or more object in the surrounding into the respective one of the first image area and the second image area are described in P. Andersen et al: “Bottom-Up and Top-Down Attention for Image Captioning and Visual Question Answering”, 2018 IEEE/CVF Conference on Computer Vision and Pattern Recognition, 2018, pp. 6077-6086, DOI: 10.1109/CVPR.2018.00636 and W. Li et al. “Object-driven Text-to-Image Synthesis via Adversarial Training”, https://arxiv.org/pdf/1902.10740.pdf, the content of which is incorporated herein by reference. However, it is to be noted that the present disclosure is not limited to the two exemplary machine-learning models listed above. Other machine-learning models may be used as well.

According to some examples, the processing circuitry 120 may be further configured to scene transform at least part of the scene using a trained machine-learning model. For example, if the first image 200 depicts a day scene, the processing circuitry 120 may transfer it to a night scene, and vice versa, for the second image 500. In other examples, if the first image 200 depicts a summer scene, the processing circuitry 120 may transfer it to a winter scene, and vice versa, for the second image 500. Further dehazing or defogging may take place. In addition, one or more object in the scene may be replaced by a respective other object (metadata may be updated for this purpose if required). Exemplary machine-learning models that may be used for scene transforming at least part of the scene are described in Y. Li et. al., “A Closed-form Solution to Photorealistic Image Stylization”, https://arxiv.org/abs/1802.06474 and J-Y Zhu et al., “Unpaired Image-to-Image Translation using Cycle-Consistent Adversarial Networks”, https://arxiv.org/abs/1703.10593, the content of which is incorporated herein by reference. However, it is to be noted that the present disclosure is not limited to these specific examples of machine-learning models. Other machine-learning models may be used as well.

Similar to what is described above, the processing circuitry 120 may store the second image data 102 (after completion of the surrounding) in the memory 130. Further, the processing circuitry 120 may discard the third image data 103 after generating the second image data 102. Accordingly, the autocompleted second image may be stored in an efficient manner.

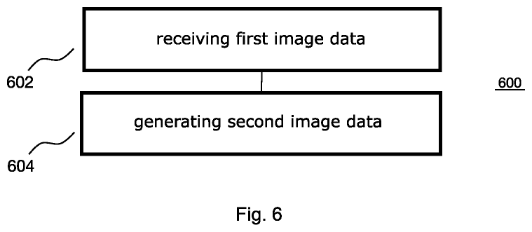

For further illustrating the above described image processing, FIG. 6 illustrates a flowchart of an (e.g. computer-implemented) image processing method 600. The method 600 comprises receiving 602 first image data representing a first image exhibiting a first aspect ratio smaller than one. The first image is a photograph or a still frame of a recorded video. In addition, the method 600 comprises generating 604 second image data representing a second image exhibiting a second aspect ratio greater than one. Generating 604 the second image data comprises adding a first image area and a second image area to the first image at opposite lateral sides of the first image. Additionally, generating 604 the second image data comprises extending a background in the first image into the first and the second image area. Generating 604 the second image data comprises further comprises identifying at least one foreground object in the first image and determining whether the foreground object is complete in the first image. If it is determined that the foreground object is not complete in the first image, generating 604 the second image data additionally comprises determining a visual representation of a missing part of the foreground object, and arranging the visual representation of a missing part into one of the first image area and the second image area to complete the foreground object.

The method 600 may allow to autocomplete non-existent lateral margins of the first image for converting the first image to the second image. For example, the method 600 may allow to convert an image from portrait format to landscape format. In particular, the method 600 may allow to complete the scene in the first image by extending the background and by autocompleting the foreground based on the foreground objects visible in the first image. The method 600 may, hence, enable aspect ratio conversion of images with compelling quality.

More details and aspects of the method 600 are explained in connection with the proposed technique or one or more examples described above (e.g. FIG. 1 to FIG. 5). The method 600 may comprise one or more additional optional features corresponding to one or more aspects of the proposed technique or one or more examples described above.

In the above example, when a photo is made with a camera and afterwards the camera is slightly moved left-right and/or up-down, the additional image data is processed to register objects, identify the objects and calculate the coordinates relative to the original photo. As described above, these pieces of information may be recorded as metadata of the photo. Accordingly, the photo may be completed to, e.g., landscape by not only extending the background and completing the foreground (such as the completion of the tree 230 in the example of FIG. 3). It is possible to additionally add objects that are not visible in the portrait photo by retrieving their information from the metadata. For example, if the metadata indicates a mountain in the left-upper corner, a house left from the front tree, and duck in the right lower corner as illustrated in the example of FIG. 5, the photo may be completed with these objects.

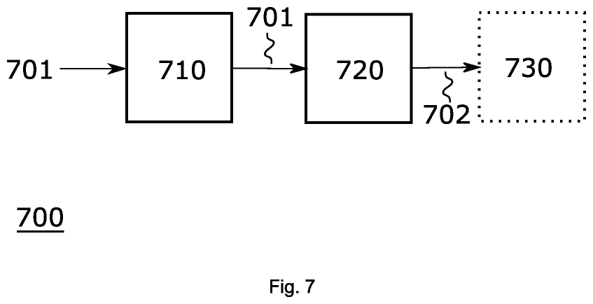

In order to highlight the processing of the metadata with more details, FIG. 7 illustrates another image processing device 700.

The image processing device 700 comprises interface circuitry 710 configured to receive first image data 701 representing a first image exhibiting a first aspect ratio smaller than one. The first image is a photograph or a still frame of a recorded video depicting a scene. The first image data 701 additionally comprise metadata indicative of a respective class, a respective size and a respective position of one or more object in a surrounding of the scene. The surrounding of the scene is not depicted in the first image. For example, the first image data 701 may be generated as described above with respect to FIG. 4 and FIG. 5 by the image processing device 100.

The image processing device 700 further comprises processing circuitry 720. The processing circuitry 720 is coupled to the interface circuitry 710. The processing circuitry 720 is configured to receive and process the first image data 701. In particular, the processing circuitry 720 is configured to generate, based on the first image data 701, second image data 702 representing a second image exhibiting a second aspect ratio greater than one.

For generating the second image data, the processing circuitry 720 is configured to add a first image area and a second image area to the first image at opposite lateral sides of the first image as described above. Additionally, for generating the second image data, the processing circuitry is configured to extend a background in the first image into the first and the second image area, and to identify at least one foreground object in the first image as described above. Further, for generating the second image data, the processing circuitry is configured to determine whether the foreground object is complete in the first image as described above. If it is determined that the foreground object is not complete in the first image, the processing circuitry is configured to determine a visual representation of a missing part of the foreground object and to arrange the visual representation of the missing part into one of the first image area and the second image area to complete the foreground object as described above. The above processing may be performed by the processing circuitry 720 as described above for the processing circuitry 120.

Additionally, the processing circuitry 720 is configured to determine a respective visual representation of the one or more object in the surrounding based on the respective class and the respective size of the one or more object indicated by the metadata. The processing circuitry 720 is in addition configured to add the respective visual representation of the one or more object in the surrounding into a respective one of the first image area and the second image area based on the respective position of the one or more object indicated by the metadata. The above processing may be performed by the processing circuitry 720 as described above for the processing circuitry 120. The processing circuitry 720 may, e.g., be configured to determine and add the respective visual representation of the one or more object in the surrounding into the respective one of the first image area and the second image area using a trained machine-learning model. For example, the machine-learning models described in the above listed publications of P. Andersen et al and W. Li et al may be used for determining and adding the respective visual representation of the one or more object in the surrounding into the respective one of the first image area and the second image area. However, it is to be noted that the present disclosure is not limited to the two exemplary machine-learning models listed above. Other machine-learning models may be used as well.

Optionally, the processing circuitry 720 may be configured to scene transform at least part of the scene using a trained machine-learning model as described above.

The processing circuitry 720 may be further configured to store the second image data 702 in a memory 730. The memory 730 may allow further circuitry to access the completed second image as represented by the second image data 702.

The image processing device 700 may allow to complete the first image based on the information about the one or more object in the scene's surrounding provided by the metadata. The metadata allow to efficiently store the information on the one or more object not visible in the first image. Accordingly, the image processing device 700 may allow to convert the efficiently stored image information to an image recognizable by a user.

For example, when a user wants to view a portrait photo completed to landscape, the portrait photo is loaded together with its metadata of surrounding objects (if available) and the portrait photo and the objects are transformed to the landscape photo as described above.

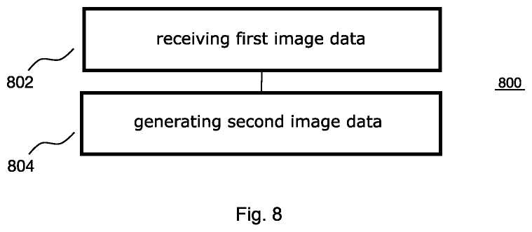

FIG. 8 illustrates a flowchart of a corresponding (e.g. computer-implemented) image processing method 800.

The method 800 comprises receiving 802 first image data representing a first image exhibiting a first aspect ratio smaller than one. The first image is a photograph or a still frame of a recorded video depicting a scene. The first image data comprise metadata indicative of a respective class, a respective size and a respective position of one or more object in a surrounding of the scene. The surrounding of the scene is not depicted in the first image. The method 800 further comprises generating 804 second image data representing a second image exhibiting a second aspect ratio greater than one.

Generating 804 the second image data comprises adding a first image area and a second image area to the first image at opposite lateral sides of the first image. Further, generating 804 the second image data comprises extending a background in the first image into the first and the second image area. In addition, generating 804 the second image data comprises determining a respective visual representation of the one or more object in the surrounding based on the respective class and the respective size of the one or more object indicated by the metadata. Generating 804 the second image data further comprises adding the respective visual representation of the one or more object in the surrounding into a respective one of the first image area and the second image area based on the respective position of the one or more object indicated by the metadata. Additionally, generating 804 the second image data comprises identifying at least one foreground object in the first image and determining whether the foreground object is complete in the first image. If it is determined that the foreground object is not complete in the first image, generating 804 the second image data comprises determining a visual representation of a missing part of the foreground object, and arranging the visual representation of the missing part into one of the first image area and the second image area to complete the foreground object.

The method 800 may allow to complete the first image based on the information about the one or more object in the scene's surrounding provided by the metadata. The metadata allow to efficiently store the information on the one or more object not visible in the first image. Accordingly, the method 800 may allow to convert the efficiently stored image information to an image recognizable by a user.

More details and aspects of the method 800 are explained in connection with the proposed technique or one or more examples described above (e.g. FIG. 4, FIG. 5 or FIG. 7). The method 800 may comprise one or more additional optional features corresponding to one or more aspects of the proposed technique or one or more examples described above.

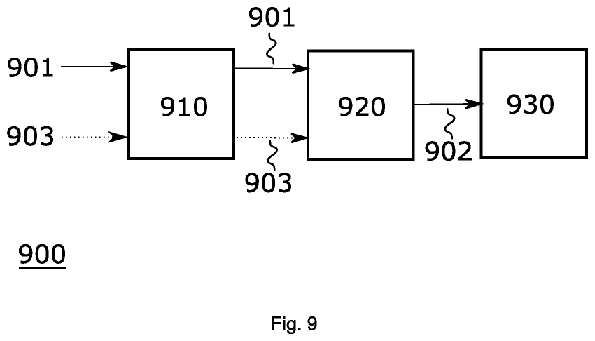

In the above examples, whole pictures are stored after autocompletion. However, the present disclosure is not limited thereto. In some examples, an entire photo may be compressed to metadata and be reconstructed based on the coordinates of foreground objects and/or other objects in the image. For further highlighting this type of image processing, FIG. 9 illustrates another image processing device 900.

The image processing device 900 comprises interface circuitry 910 configured to receive first image data 901 representing a first image. The first image exhibits a first aspect ratio smaller than one. The first image is a photograph or a still frame of a recorded video. For example, the first image may be like the image 200 illustrated in FIG. 2.

The image processing device 900 comprises processing circuitry 920. The processing circuitry 920 is coupled to the interface circuitry 910. The processing circuitry 920 is configured to receive and process the first image data 901. In particular, the processing circuitry 920 is configured to identify a background in the first image as described above. Further, the processing circuitry 920 is configured to identify one or more foreground object in the first image and to determine a respective size and a respective position of the one or more foreground object as described above. For example, when identifying the one or more one or more foreground object, the processing circuitry 920 may be configured to determine a respective bounding box for the one or more one or more foreground object as illustrated in FIG. 4 for the duck 260. Accordingly, the respective size and the respective position of the one or more one or more foreground object may be a respective size and a respective position of the respective bounding box for the one or one or more foreground object.

The processing circuitry 920 is further configured to generate second image data 902 indicative of a respective class, the respective size and the respective position of the one or more foreground object. The second image data 902 is further indicative of a class of the background.

The processing circuitry 920 is configured to store the second image data 902 in a memory 930.

Rather than saving the entire first image, the image processing device 900 extracts and stores only metadata about foreground objects and the background of the first image. In other words, the first image is not stored in its entirety. Accordingly, the first image may be stored in an efficient manner. The first image may be reconstructed based on the metadata given in the second image data 902.

Analogously to what is described above, the processing circuitry 920 may be further configured to determine for the one or more foreground object in the first image whether the respective foreground object is complete in the first image. Accordingly, the second image data 902 may be further indicative of whether the respective foreground object is complete in the first image. The information about whether the respective foreground object is complete in the first image may allow circuitry reconstructing an image based on the second image data 902 to perform autocompletion on the respective foreground object (e.g. as described above).

Analogously to what is described above, the interface circuitry 910 may further be configured to receive third image data 903 representing a surrounding of the scene that is depicted in the first image. The surrounding is not depicted in the first image. As described above, the third image data 903 may be obtained by moving a camera left-right and/or up-down after shooting the first image. Accordingly, the processing circuitry 920 may be further configured to identify one or more object in the surrounding such as the duck 260 in the example of FIG. 4, and to determine a respective size and a respective position of the one or more object in the surrounding relative to the scene depicted in the first image. For example, when identifying the one or more object in the surrounding, the processing circuitry 920 may be configured to determine a respective bounding box for the one or more object in the surrounding as is described above with respect to FIG. 4 for the duck 260. Accordingly, the respective size and the respective position of the one or more object in the surrounding may be a respective size and a respective position of the respective bounding box for the one or more object in the surrounding. The processing circuitry 920 is configured to generate the second image data to be further indicative of a respective class, the respective size and the respective position of the one or more object in the surrounding.

The additional information about the one or more object in the surrounding may allow to further reconstruct objects in the surrounding of the underlying first image. Accordingly, also lateral side margins may be populated when reconstructing an image with an aspect ratio greater than one based on the second image data 902. For example, the respective class, the respective size and the respective position of the one or more foreground object, the class of the background and optionally further the information about whether the respective foreground object is complete in the first image and further optionally the respective class, the respective size and the respective position of the one or more object in the surrounding may be indicated (exclusively) as textual information in the second image data 902 such that an image may be reconstructed from the second image data 902 by means of a trained machine-learning model for text-to-image syntheses.

According to examples, the processing circuitry 920 may further be configured to synthesize a second image exhibiting a second aspect ratio greater than one based on the second image data 920 using a trained machine-learning model for text-to-image syntheses. For example, the machine-learning models described in the above listed publications of P. Andersen et al and W. Li et al may be used for synthesizing the second image. However, it is to be noted that the present disclosure is not limited to these specific examples of machine-learning models. Other machine-learning models may be used as well.

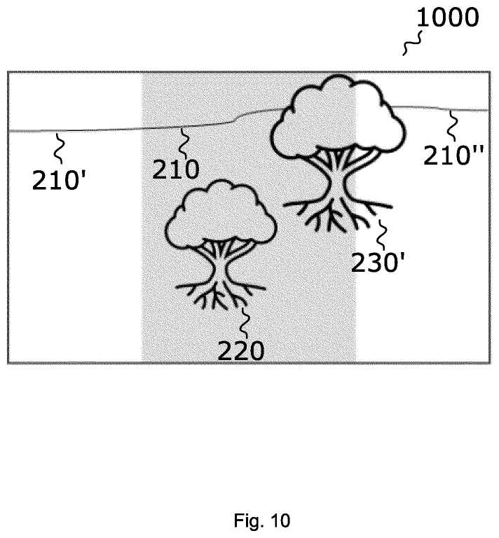

When reconstructing the second image, the processing circuitry 920 may optionally further be configured to determine a respective confidence value for one or more synthesized object in the second image. The one or more synthesized object in the second image being synthesized based on the second image data. An exemplarily synthesized image 1000 is illustrated in FIG. 10. In the example of FIG. 10, the second image data 902 indicate the class of the background 210 as well as the respective class, the respective size and the respective position of the two foreground objects 220 and 230. In particular, the second image data 902 indicate by means of the that the two foreground objects 220 and 230 are trees. Further, the second image data 902 indicate that the tree 230 is not complete in the first image. The image area of the first image is grayed out in the example of FIG. 10. The processing circuitry 920 reconstructs the second image using a trained machine-learning model for text-to-image syntheses, extends the background 210 and autocompletes the tree 230 to the complete tree 230′ as described above. The respective confidence value for the one or more synthesized object in the second image enables the processing circuitry 920 to adjust a respective blurriness of the one or more synthesized object in the second image based on the respective confidence value. For example, the processing circuitry 920 may increase a blurriness for a synthesized object with decreasing confidence value of the object, and vice versa.

Analogously to what is described above, when synthesizing the second image, the processing circuitry 920 may be further configured to scene transform at least part of a scene described by the second image data 902 using a trained machine-learning model. This is illustrated in FIG. 10 by means of the trees 220 and 230′, whose color is changed to transfer the scene to a winter scene.

The present disclosure further provides an image processing device comprising interface circuitry configured to receive the second image data described above with respect to FIG. 9 and FIG. 10. The image processing device further comprises processing circuitry configured to synthesize a second image exhibiting a second aspect ratio greater than one based on the second image data using a trained machine-learning model for text-to-image syntheses as described above with respect to FIG. 9 and FIG. 10. In other words, the image processing device is identical to the image processing device 900 except that the generation of the second image data is omitted.

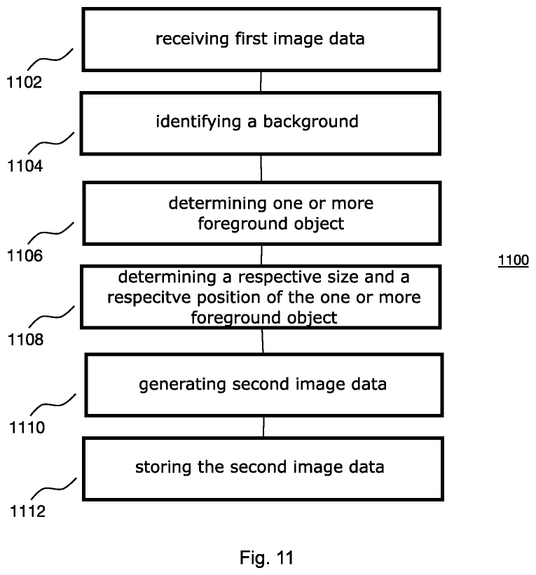

For further illustrating the above described image processing, FIG. 11 illustrates a flowchart of an (e.g. computer-implemented) image processing method 1100. The method 1100 comprises receiving 1102 first image data representing a first image exhibiting a first aspect ratio smaller than one. The first image is a photograph or a still frame of a recorded video. The method 1100 further comprises identifying 1104 a background in the first image and identifying 1106 one or more foreground object in the first image. Additionally, the method 1100 comprises determining 1108 a respective size and a respective position of the one or more foreground object. Further, the method 1100 comprises generating 1110 second image data indicative of a respective class, the respective size and the respective position of the one or more foreground object and of a class of the background. The method 1100 comprises storing 1112 the second image data in a memory.

The method 1100 may allow to store the first image in an efficient manner. Rather than saving the entire first image, only metadata about foreground objects and the background of the first image are extracted and stored. The first image may be reconstructed based on the metadata given in the second image data.

More details and aspects of the method 1100 are explained in connection with the proposed technique or one or more examples described above (e.g. FIG. 9 or FIG. 10). The method 1100 may comprise one or more additional optional features corresponding to one or more aspects of the proposed technique or one or more examples described above.

In case the first image is a still frame of a recorded video, the above described processing may be performed for all still frames of the recorded video.

The image data generated according to the above described processing may be display on various devices such as a monitor, a TV set, a projector, a head-mounted display (e.g. a Virtual Reality, VR, headset), etc.

The image processing devices according to the present disclosure may be implemented in the same device as an image sensor used for shooting the first image. Alternatively, the image processing devices according to the present disclosure may be provided in different devices.

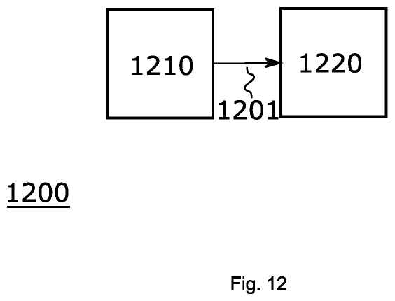

FIG. 12 illustrates an electronic device 1200 such as a camera, a mobile phone, a tablet-computer or a head-mounted display (e.g. a VR headset). The electronic device 1200 comprises an image processing device 1220 according to the present disclosure. Additionally, the electronic device 1200 comprises an image sensor 1210. The image sensor 1210 is configured to generate the first image data 1201 based on light received from a scene. The image processing device 1220 processes the first image data 1201 as described above. For example, the image sensor 1210 may be a Charge-Coupled Device (CCD) or an Active Pixel Sensor (APS; e.g. a Complementary Metal-Oxide-Semiconductor, CMOS, APS). However, it is to be noted that the present disclosure is not limited thereto.

As illustrated in FIG. 12, the image processing device 1220 may be separate from the image sensor 1210 such that the image processing device 1220 is coupled to the image sensor 1210. In other examples, the image processing device 1220 may be integrated into the image sensor 1210.

For example, the electronic device 1200 may be a camera device that may allow to complete margins of a portrait photography to a landscape or to a panorama or to an all-around photography. When capturing the photography, foreground objects may be identified and be recorded with coordinates in metadata as described above. In reconstruction, the background may be extended and foreground objects may be completed based on the metadata information as described above. Many edge devices have limited memory which makes it important to record and store photographies or videos in a more storage efficient way. Wide angle photographies or all-around photos photographies require a lot of storage. The proposed technique may allow to reduce the required storage space dramatically.

The electronic device 1200 may optionally comprise a display (not illustrated in FIG. 12) configured to display the image data generated by the image processing device 1220 based on the first image data 1201.

Examples of the present disclosure may enable video content generation to expand the video format and content from portrait to landscape to 360-degree video format.

The following examples pertain to further embodiments:

(1) An image processing device, comprising:
interface circuitry configured to receive first image data representing a first image exhibiting a first aspect ratio smaller than one, the first image being a photograph or a still frame of a recorded video; and
processing circuitry configured to generate second image data representing a second image exhibiting a second aspect ratio greater than one, wherein, for generating the second image data, the processing circuitry is configured to:
   add a first image area and a second image area to the first image at opposite lateral sides of the first image;
   extend a background in the first image into the first and the second image area; identify at least one foreground object in the first image;
   determine whether the foreground object is complete in the first image; and
   if it is determined that the foreground object is not complete in the first image, determine a visual representation of a missing part of the foreground object and arrange the visual representation of the missing part into one of the first image area and the second image area to complete the foreground object.

(2) The image processing device of (1), wherein the first image area and the second image area exhibit a same height as the first image.

(3) The image processing device of (1) or (2), wherein, for generating the second image data, the processing circuitry is further configured to identify the background in the first image prior to extending the background into the first image area and the second image area.

(4) The image processing device of any one of (1) to (3), wherein the processing circuitry is configured to extend the background into the first image area and the second image area using a trained machine-learning model.

(5) The image processing device of any one of (1) to (4), wherein the processing circuitry is configured to determine and arrange the visual representation of the missing part of the foreground object into the one of the first image area and the second image area using a trained machine-learning model.

(6) The image processing device of any one of (1) to (5), wherein a scene is depicted in the first image, wherein the interface circuitry is further configured to receive third image data representing a surrounding of the scene not depicted in the first image, and wherein, for generating the second image data, the processing circuitry is further configured to:
identify one or more object in the surrounding;
determine a respective size and a respective position of the one or more object in the surrounding relative to the scene depicted in the first image; and
add metadata to the second image data indicative of a respective class, the respective size and the respective position of the one or more object in the surrounding.

(7) The image processing device of any one of (1) to (5), wherein a scene is depicted in the first image, wherein the interface circuitry is further configured to receive third image data representing a surrounding of the scene not depicted in the first image, and wherein, for generating the second image data, the processing circuitry is further configured to:
identify one or more object in the surrounding;
determine a respective class, a respective size and a respective position of the one or more object in the surrounding relative to the scene depicted in the first image;
determine a respective visual representation of the one or more object in the surrounding based on the respective determined class and the respective determined size of the one or more object in the surrounding; and
add the respective visual representation of the one or more object in the surrounding into a respective one of the first image area and the second image area based on the respective determined position of the one or more object in the surrounding.

(8) The image processing device of (6) or (7), wherein, when identifying the one or more object in the surrounding, the processing circuitry is configured to determine a respective bounding box for the one or more object in the surrounding, and wherein the respective size and the respective position of the one or more object in the surrounding is a respective size and a respective position of the respective bounding box for the one or more object in the surrounding.

(9) The image processing device of any one of (6) to (8), wherein the processing circuitry is further configured to store the second image data in a memory and to discard the third image data after generating the second image data.

(10) An image processing device, comprising:
interface circuitry configured to receive first image data representing a first image exhibiting a first aspect ratio smaller than one, wherein the first image is a photograph or a still frame of a recorded video depicting a scene, and wherein the first image data comprise metadata indicative of a respective class, a respective size and a respective position of one or more object in a surrounding of the scene not depicted in the first image; and
processing circuitry configured to generate second image data representing a second image exhibiting a second aspect ratio greater than one, wherein, for generating the second image data, the processing circuitry is configured to:
   add a first image area and a second image area to the first image at opposite lateral sides of the first image;
   extend a background in the first image into the first and the second image area; identify at least one foreground object in the first image;
   determine whether the foreground object is complete in the first image;
   if it is determined that the foreground object is not complete in the first image, determine a visual representation of a missing part of the foreground object and arrange the visual representation of the missing part into one of the first image area and the second image area to complete the foreground object;
   determine a respective visual representation of the one or more object in the surrounding based on the respective class and the respective size of the one or more object indicated by the metadata; and
   add the respective visual representation of the one or more object in the surrounding into a respective one of the first image area and the second image area based on the respective position of the one or more object indicated by the metadata.

(11) The image processing device of (7) or (10), wherein the processing circuitry is configured to determine and add the respective visual representation of the one or more object in the surrounding into the respective one of the first image area and the second image area using a trained machine-learning model.

(12) The image processing device of (7), (10) or (11), wherein the processing circuitry is configured to scene transform at least part of the scene using a trained machine-learning model.

(13) An image processing device, comprising:
interface circuitry configured to receive first image data representing a first image exhibiting a first aspect ratio smaller than one, the first image being a photograph or a still frame of a recorded video; and
processing circuitry configured to:
   identify a background in the first image;
   identify one or more foreground object in the first image;
   determine a respective size and a respective position of the one or more foreground object;
   generate second image data indicative of a respective class, the respective size and the respective position of the one or more foreground object and of a class of the background; and
   store the second image data in a memory.

(14) The image processing device of (13), wherein the processing circuitry is further configured to determine for the one or more foreground object in the first image whether the respective foreground object is complete in the first image, and wherein the second image data is further indicative of whether the respective foreground object is complete in the first image.

(15) The image processing device of (13) or (14), wherein, when identifying the one or more one or more foreground object, the processing circuitry is configured to determine a respective bounding box for the one or more one or more foreground object, and wherein the respective size and the respective position of the one or more one or more foreground object is a respective size and a respective position of the respective bounding box for the one or one or more foreground object.

(16) The image processing device of any one of (13) to (15), wherein a scene is depicted in the first image, wherein the interface circuitry is further configured to receive third image data representing a surrounding of the scene not depicted in the first image, and wherein the processing circuitry is further configured to:
identify one or more object in the surrounding; and
determine a respective size and a respective position of the one or more object in the surrounding relative to the scene depicted in the first image;
wherein the second image data is further indicative of a respective class, the respective size and the respective position of the one or more object in the surrounding.

(17) The image processing device of (16), wherein, when identifying the one or more object in the surrounding, the processing circuitry is configured to determine a respective bounding box for the one or more object in the surrounding, and wherein the respective size and the respective position of the one or more object in the surrounding is a respective size and a respective position of the respective bounding box for the one or more object in the surrounding.

(18) The image processing device of any one of (13) to (17), wherein the processing circuitry is further configured to:
synthesize a second image exhibiting a second aspect ratio greater than one based on the second image data using a trained machine-learning model for text-to-image syntheses.

(19) The image processing device of (18), wherein the processing circuitry is further configured to:
determine a respective confidence value for one or more synthesized object in the second image, the one or more synthesized object in the second image being synthesized based on the second image data; and
adjust a respective blurriness of the one or more synthesized object in the second image based on the respective confidence value.

(20) The image processing device of (18) or (19), wherein, when synthesizing the second image, the processing circuitry is configured to scene transform at least part of a scene described by the second image data using a trained machine-learning model.

(21) An electronic device, comprising:
an image processing device according to any one of (1) to (20); and
an image sensor configured to generate the first image data based on light received from a scene.

(22) The electronic device of (21), wherein the image processing device is integrated into the image sensor.

(23) An image processing method, comprising:
receiving first image data representing a first image exhibiting a first aspect ratio smaller than one, the first image being a photograph or a still frame of a recorded video; and
generating second image data representing a second image exhibiting a second aspect ratio greater than one, wherein generating the second image data comprises:
   adding a first image area and a second image area to the first image at opposite lateral sides of the first image;
   extending a background in the first image into the first and the second image area;
   identifying at least one foreground object in the first image;
   determining whether the foreground object is complete in the first image; and
   if it is determined that the foreground object is not complete in the first image:
      determining a visual representation of a missing part of the foreground object; and
      arranging the visual representation of the missing part into one of the first image area and the second image area to complete the foreground object.

(24) An image processing method, comprising:
receiving first image data representing a first image exhibiting a first aspect ratio smaller than one, wherein the first image is a photograph or a still frame of a recorded video depicting a scene, and wherein the first image data comprise metadata indicative of a respective class, a respective size and a respective position of one or more object in a surrounding of the scene not depicted in the first image;
generating second image data representing a second image exhibiting a second aspect ratio greater than one, wherein generating the second image data comprises:
   adding a first image area and a second image area to the first image at opposite lateral sides of the first image;
   extending a background in the first image into the first and the second image area;
   determining a respective visual representation of the one or more object in the surrounding based on the respective class and the respective size of the one or more object indicated by the metadata;
   adding the respective visual representation of the one or more object in the surrounding into a respective one of the first image area and the second image area based on the respective position of the one or more object indicated by the metadata;
   identifying at least one foreground object in the first image;
   determining whether the foreground object is complete in the first image; and
   if it is determined that the foreground object is not complete in the first image:
      determining a visual representation of a missing part of the foreground object; and
      arranging the visual representation of the missing part into one of the first image area and the second image area to complete the foreground object.

(25) An image processing method, comprising:
receiving first image data representing a first image exhibiting a first aspect ratio smaller than one, the first image being a photograph or a still frame of a recorded video; and identifying a background in the first image;
identifying one or more foreground object in the first image;
determining a respective size and a respective position of the one or more foreground object;
generating second image data indicative of a respective class, the respective size and the respective position of the one or more foreground object and of a class of the background; and
storing the second image data in a memory.

(26) A non-transitory machine-readable medium having stored thereon a program having a program code for performing the method according to any one of (23) to (25), when the program is executed on a processor or a programmable hardware.

(27) A program having a program code for performing the method according to any one of (23) to (25), when the program is executed on a processor or a programmable hardware.

The aspects and features described in relation to a particular one of the previous examples may also be combined with one or more of the further examples to replace an identical or similar feature of that further example or to additionally introduce the features into the further example.

A non-transitory machine-readable medium may, e.g., be digital data storage media, which are machine-, processor- or computer-readable and encode and/or contain machine-executable, processor-executable or computer-executable programs and instructions. For example, a non-transitory machine-readable medium may include or be a digital storage device, a magnetic storage medium such as magnetic disks and magnetic tapes, a hard disk drive, or optically readable digital data storage media.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An image processing device, comprising:
interface circuitry configured to receive first image data representing a first image exhibiting a first aspect ratio smaller than one, the first image being a photograph or a still frame of a recorded video; and
processing circuitry configured to generate second image data representing a second image exhibiting a second aspect ratio greater than one, wherein, for generating the second image data, the processing circuitry is configured to:
add a first image area and a second image area to the first image at opposite lateral sides of the first image;
extend a background in the first image into the first and the second image area;
identify at least one foreground object in the first image;
determine whether the foreground object is complete in the first image; and
if it is determined that the foreground object is not complete in the first image, determine a visual representation of a missing part of the foreground object and arrange the visual representation of the missing part into one of the first image area and the second image area to complete the foreground object.

2. The image processing device of claim 1, wherein the first image area and the second image area exhibit a same height as the first image.

3. The image processing device of claim 1, wherein, for generating the second image data, the processing circuitry is further configured to identify the background in the first image prior to extending the background into the first image area and the second image area.

4. The image processing device of claim 1, wherein the processing circuitry is configured to extend the background into the first image area and the second image area using a trained machine-learning model.

5. The image processing device of claim 1, wherein the processing circuitry is configured to determine and arrange the visual representation of the missing part of the foreground object into the one of the first image area and the second image area using a trained machine-learning model.

6. The image processing device of claim 1, wherein a scene is depicted in the first image, wherein the interface circuitry is further configured to receive third image data representing a surrounding of the scene not depicted in the first image, and wherein, for generating the second image data, the processing circuitry is further configured to:
identify one or more object in the surrounding;
determine a respective size and a respective position of the one or more object in the surrounding relative to the scene depicted in the first image; and
add metadata to the second image data indicative of a respective class, the respective size and the respective position of the one or more object in the surrounding.

7. The image processing device of claim 1, wherein a scene is depicted in the first image, wherein the interface circuitry is further configured to receive third image data representing a surrounding of the scene not depicted in the first image, and wherein, for generating the second image data, the processing circuitry is further configured to:
identify one or more object in the surrounding;
determine a respective class, a respective size and a respective position of the one or more object in the surrounding relative to the scene depicted in the first image;
determine a respective visual representation of the one or more object in the surrounding based on the respective determined class and the respective determined size of the one or more object in the surrounding; and
add the respective visual representation of the one or more object in the surrounding into a respective one of the first image area and the second image area based on the respective determined position of the one or more object in the surrounding.

8. The image processing device of claim 6, wherein, when identifying the one or more object in the surrounding, the processing circuitry is configured to determine a respective bounding box for the one or more object in the surrounding, and wherein the respective size and the respective position of the one or more object in the surrounding is a respective size and a respective position of the respective bounding box for the one or more object in the surrounding.

9. The image processing device of claim 6, wherein the processing circuitry is further configured to store the second image data in a memory and to discard the third image data after generating the second image data.

10. An image processing device, comprising:
interface circuitry configured to receive first image data representing a first image exhibiting a first aspect ratio smaller than one, wherein the first image is a photograph or a still frame of a recorded video depicting a scene, and wherein the first image data comprise metadata indicative of a respective class, a respective size and a respective position of one or more object in a surrounding of the scene not depicted in the first image; and
processing circuitry configured to generate second image data representing a second image exhibiting a second aspect ratio greater than one, wherein, for generating the second image data, the processing circuitry is configured to:
add a first image area and a second image area to the first image at opposite lateral sides of the first image;
extend a background in the first image into the first and the second image area;
identify at least one foreground object in the first image;
determine whether the foreground object is complete in the first image;
if it is determined that the foreground object is not complete in the first image, determine a visual representation of a missing part of the foreground object and arrange the visual representation of the missing part into one of the first image area and the second image area to complete the foreground object;
determine a respective visual representation of the one or more object in the surrounding based on the respective class and the respective size of the one or more object indicated by the metadata; and
add the respective visual representation of the one or more object in the surrounding into a respective one of the first image area and the second image area based on the respective position of the one or more object indicated by the metadata.

11. The image processing device of claim 10, wherein the processing circuitry is configured to determine and add the respective visual representation of the one or more object in the surrounding into the respective one of the first image area and the second image area using a trained machine-learning model.

12. The image processing device of claim 10, wherein the processing circuitry is configured to scene transform at least part of the scene using a trained machine-learning model.

13. An image processing device, comprising:
interface circuitry configured to receive first image data representing a first image exhibiting a first aspect ratio smaller than one, the first image being a photograph or a still frame of a recorded video; and
processing circuitry configured to:
identify a background in the first image;
identify one or more foreground object in the first image;
determine a respective size and a respective position of the one or more foreground object;
generate second image data indicative of a respective class, the respective size and the respective position of the one or more foreground object and of a class of the background; and
store the second image data in a memory.

14. The image processing device of claim 13, wherein the processing circuitry is further configured to determine for the one or more foreground object in the first image whether the respective foreground object is complete in the first image, and wherein the second image data is further indicative of whether the respective foreground object is complete in the first image.

15. The image processing device of claim 13, wherein a scene is depicted in the first image, wherein the interface circuitry is further configured to receive third image data representing a surrounding of the scene not depicted in the first image, and wherein the processing circuitry is further configured to:
identify one or more object in the surrounding; and
determine a respective size and a respective position of the one or more object in the surrounding relative to the scene depicted in the first image;
wherein the second image data is further indicative of a respective class, the respective size and the respective position of the one or more object in the surrounding.

16. The image processing device of claim 13, wherein the processing circuitry is further configured to:
synthesize a second image exhibiting a second aspect ratio greater than one based on the second image data using a trained machine-learning model for text-to-image syntheses.

17. The image processing device of claim 16, wherein the processing circuitry is further configured to:
determine a respective confidence value for one or more synthesized object in the second image, the one or more synthesized object in the second image being synthesized based on the second image data; and
adjust a respective blurriness of the one or more synthesized object in the second image based on the respective confidence value.

18. The image processing device of claim 16, wherein, when synthesizing the second image, the processing circuitry is configured to scene transform at least part of a scene described by the second image data using a trained machine-learning model.

19. An electronic device, comprising:
an image sensor configured to generate the first image data based on light received from a scene; and
an image processing device according to claim 1.

20. An image processing method, comprising:
receiving first image data representing a first image exhibiting a first aspect ratio smaller than one, the first image being a photograph or a still frame of a recorded video; and
generating second image data representing a second image exhibiting a second aspect ratio greater than one, wherein generating the second image data comprises:
adding a first image area and a second image area to the first image at opposite lateral sides of the first image;
extending a background in the first image into the first and the second image area;
identifying at least one foreground object in the first image;
determining whether the foreground object is complete in the first image; and
if it is determined that the foreground object is not complete in the first image:
determining a visual representation of a missing part of the foreground object; and
arranging the visual representation of the missing part into one of the first image area and the second image area to complete the foreground object.
